(19) United States
(12) Patent Application Publication
(10) Pub. No.: US 2010/0180282 A1
(43) Pub. Date: Jul. 15, 2010

(54) COMPUTER SYSTEM AND METHOD FOR INSTALLING DRIVER PROGRAM IN THE COMPUTER SYSTEM

(75) Inventors: YI-FANG WU, Tu-Cheng (TW); YONG-HUI XIAO, Shenzhen City (CN); QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HONG HAI PRECISION INDUSTRY CO., LTD., Tu-Cheng (TW)

(21) Appl. No.: 12/507,095

(22) Filed: Jul. 22, 2009

(30) Foreign Application Priority Data
Jan. 14, 2009 (CN) 200910300179.1

(51) Int. Cl. G06F 13/00; G06F 9/44; G06F 12/00; G06F 9/445

(52) U.S. Cl. 719/327; 711/112; 710/301; 717/174; 711/E12.001

(57) ABSTRACT

A computer system includes a hard disk drive with an operating system installed therein, and a PCI card communicating with the hard disk drive. The PCI card includes a storage unit, which includes a receiving module, a detection module, an installing module, and a program module storing a driver program of the PCI card being compatible with the operating system. The receiving module is capable of receiving an executing instruction sent by the operating system to the storage unit. The detection module is capable of detecting whether there is a driver program installed in the hard disk drive after the receiving module receiving the executing instruction. The installing module is capable of installing the driver program in the hard disk drive when there is no compatible driver program installed in the hard disk drive. The method for installing the driver program in the computer system is further provided.

### BACKGROUND

1. Technical Field

The present disclosure relates to computer systems and methods, and particularly to a computer system with a Peripheral Component Interconnect (PCI) card, and a method for installing a driver program in the computer system.

2. Description of Related Art

Usually, when new hardware, such as a PCI card, is secured in a computer system, a driver program of the hardware must be installed in the computer system in order for the new hardware to function properly. However, driver programs are most often stored in a disk along with other programs. Before installing the driver program, the correct disk should be found, and then the correct driver program suitable for the particular computer system and operating system, which is not convenient for users.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a computer system, in accordance with an embodiment.

FIG. 2 is a bock diagram of a storage unit of the computer system of FIG. 1, in accordance with an embodiment.

FIG. 3 is a flowchart of a method for installing a driver program in the computer system of FIG. 1, in accordance with an embodiment.

### DETAILED DESCRIPTION

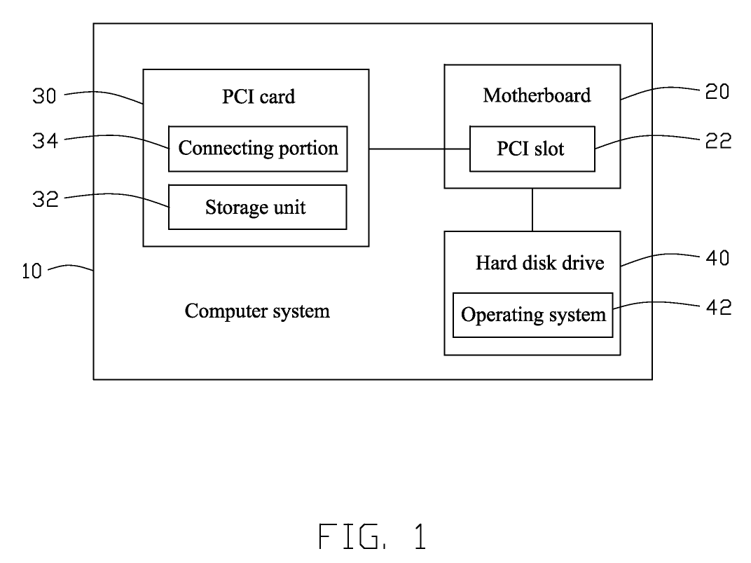

FIG. 1 illustrates a computer system 10, in accordance with an embodiment, which includes a motherboard 20, a Peripheral Component Interconnect (PCI) card 30, and a hard disk drive 40 with an operating system 42 installed therein.

The motherboard 20 is electrically coupled to the hard disk drive 40, and defines a PCI slot 22.

The PCI card 30 maybe a wireless network card, a sound card, a vide card, or a graphic card, and includes a storage unit 32 and a connecting portion 34. The storage unit 32 may be a flash memory or other storage medium, which is integrated with the PCI card 30 following the PCI or PCI express standards accordingly. The connecting portion 34 can be inserted in the PCI slot 22 of the motherboard 20 so as to electrically couple the PCI card 30 to the motherboard 20. The PCI card 30 thereby communicates with the hard disk drive 40 through the motherboard 20.

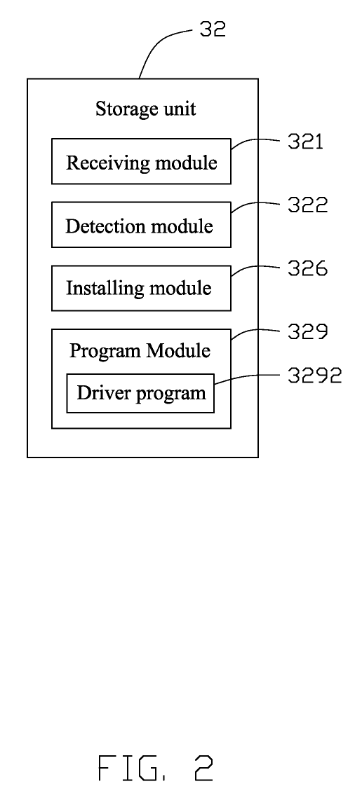

Referring also to FIG. 2, the storage unit 32 includes a receiving module 321, a detection module 322, an installing module 326, and a program module 329. The receiving module 321 is capable of receiving information and instructions sent to the storage unit 32. The detection module 322 is capable of detecting information of the operating system 42, and whether there is a driver program of the PCI card 30 already installed in the hard disk drive 40. The information of the operating system 42 includes version and name of the operating system 42. The program module 329 stores a plurality of driver programs 3292, and if one driver program 3292 compatible with the operating system 42 is installed in the hard disk drive 40, the PCI card 30 is capable of correctly executing its functions under the operating system 42. The installing module 326 is capable of installing a compatible one driver program 3292 in the hard disk drive 40 if one has not installed yet.

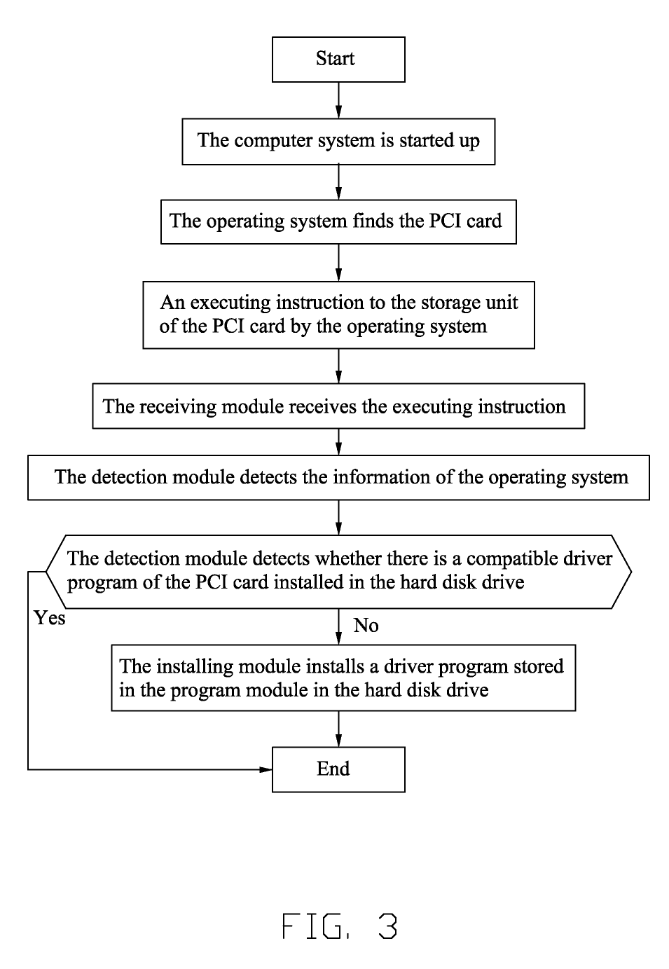

Referring also to FIG. 3, in use, the connecting portion 34 of the PCI card 30 is electrically engaged in the PCI slot 22 of the motherboard 20. The computer system 10 is then started up. The operating system 42 finds the PCI card 30, and sends an instruction to the storage unit 32 of the PCI card 30. The receiving module 321 receives the instruction, and the detection module 322 detects the information of the operating system 42 and whether there is a compatible driver program of the PCI card 30 already installed in the hard disk drive 40. If a compatible driver program is detected, the PCI card 30 can correctly execute its functions. If a compatible driver program is not detected, the installing module 326 automatically installs the one compatible driver program 3292 stored in the program module 329 in the hard disk drive 40. After the driver program 3292 is installed in the hard disk drive 40, the PCI card 30 can execute its functions under the operating system 42.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer system comprising:
a hard disk drive with an operating system installed therein; and
a Peripheral Component Interconnect (PCI) card communicating with the hard disk drive, the PCI card comprising a storage unit, the storage unit comprising a receiving module, a detection module, an installing module, and a program module storing a driver program of the PCI card being compatible with the operating system, wherein the receiving module is capable of receiving an executing instruction sent by the operating system to the storage unit, the detection module is capable of detecting whether there is a driver program of the PCI card installed in the hard disk drive after the receiving module receiving the executing instruction, the installing module is capable of installing the driver program of the PCI card in the hard disk drive when there is no compatible driver program installed in the hard disk drive.

2. The computer system of claim 1, wherein the detection module is capable of further detecting information of the operating system, the information of the operating system comprises a version and a name of the operating system.

3. The computer system of claim 1, further comprising a motherboard communicating with the hard disk drive.

4. The computer system of claim 3, wherein the motherboard defines a PCI slot, the PCI card has a connecting portion capable of electrically engaging in the PCI slot of the motherboard so that the PCI card is capable of communicating with the hard disk drive.

5. The computer system of claim 1, wherein the PCI card is a wireless network card, sound card, a vide card, or a graphic card.

6. A computer system comprising:
a hard disk drive with an operating system installed therein;
a motherboard communicating with the hard disk drive; and
a PCI card electrically coupled to the motherboard and communicating with the hard disk drive via the motherboard, the PCI card comprising a detection module, an installing module, and a program module storing a driver program of the PCI card being compatible with the operating system, wherein the detection module is capable of detecting whether there is a driver program for the PCI card installed in the hard disk drive, the installing module is capable of installing the driver program of the PCI card in the hard disk drive when there is no compatible driver program installed in the hard disk drive.

7. The computer system of claim 6, wherein the PCI card further comprises a receiving module, the receiving module is capable of receiving an executing instruction sent by the operating system to the storage unit.

8. The computer system of claim 6, wherein the detection module is capable of further detecting information of the operating system, the information of the operating system comprises a version and a name of the operating system.

9. The computer system of claim 6, wherein the motherboard defines a PCI slot, the PCI card has a connecting portion capable of electrically engaging in the PCI slot of the motherboard.

10. The computer system of claim 6, wherein the PCI card is a wireless network card, sound card, a vide card, or a graphic card.

11. A method for installing a driver program in a computer system with an operating system installed therein, the method comprising steps:
a receiving module of a PCI card receiving an executing instruction sent to the PCI card of the computer system;
a detecting module of the PCI card detecting whether there is a compatible driver program of the PCI card installed in the computer system; and
an installing module of the PCI card installing a driver program stored in a program module of the PCI card in the computer system if there is no compatible driver program of the PCI card installed in the computer system.

12. The method of claim 11, further comprising the detection module detecting information of the operating system when whether there is a compatible driver program of the PCI card installed in the computer system.

13. The method of claim 12, wherein the information of the operating system comprises a version and a name of the operating system.
